(19) United States
(12) Patent Application Publication
(10) Pub. No.: US 2015/0084216 A1
(43) Pub. Date: Mar. 26, 2015

(54) INJECTION MOLD, INJECTION-MOLDED PRODUCT, OPTICAL ELEMENT, OPTICAL PRISM, INK TANK, RECORDING DEVICE, AND INJECTION MOLDING METHOD

(71) Applicant: SEIKO EPSON CORPORATION, Tokyo (JP)

(72) Inventors: Kei YOKOTA, Yamagata-mura (JP); Daizo AOYAGI, Shiojiri-shi (JP)

(21) Appl. No.: 14/559,810

(22) Filed: Dec. 3, 2014

Related U.S. Application Data
(62) Division of application No. 13/489,335, filed on Jun. 5, 2012.

(30) Foreign Application Priority Data
Jun. 6, 2011 (JP) 2011-126689

(51) Int. Cl. B29C 45/37; B29C 45/73

(52) U.S. Cl. CPC B29C 45/37; B29C 45/73; B29K 2995/0013; B29L 2011/00
USPC 264/1.1

(57) ABSTRACT

There is provided an injection mold to manufacture an injection-molded product formed of a molten resin that is injected into a molding space and is solidified. The injection mold includes an insert that forms a high quality required surface corresponding to a high quality required surface of an injection-molded product. The high quality required surface forming insert includes a first insert member corresponding to a high surface accuracy required portion in the high quality required surface, and a second insert member corresponding to a high surface accuracy not-required portion in which the surface accuracy that is required is lower than that of the high surface accuracy required portion in the high quality required surface and which has thermal conductivity lower than that of the first insert member.

### CROSS REFERENCE TO RELATED APPLICATION

The application is a divisional of U.S. patent application Ser. No. 13/489,335, filed Jun. 5, 2012, which is expressly incorporated herein by reference in its entirety. U.S. patent application Ser. No. 13/489,335 claims priority to Japanese Patent Application No.: 2011-126689, filed Jun. 6, 2011, which is also expressly incorporated by reference herein.

### BACKGROUND

1. Technical Field

The present invention relates to an injection-molded product, for example, an optical prism or the like that has a high surface accuracy required portion which is formed at a part of one surface and in which high surface accuracy is required, an injection mold and an injection molding method to manufacture the injection-molded product.

2. Related Art

In the related art, for example, as an injection mold to manufacture an injection-molded product such as an optical element (prism), which has a high quality required surface in which high surface accuracy (flatness or the like) is required, an injection mold disclosed in JP-A-2005-238631 may be exemplified.

The injection mold disclosed in JP-A-2005-238631 has a surface layer that is formed on a base member and makes up a molding mold, and this surface layer is formed to have lower thermal conductivity than that of the base member.

However, in some of injection-molded products (optical prisms), surface accuracy higher than that of other portions is required only in a part of a high quality required surface, such as the center of the high quality required surface and the periphery of the center.

In addition, in the injection mold disclosed in JP-A-2005-238631, a surface layer, which has thermal conductivity lower than that of a base member, is provided in the molding mold on the entirety of a surface that molds a design surface of the injection-molded product, and thereby heat exchange with the mold in the design surface of the injection-molded product is made to be uniform.

Therefore, in the injection mold disclosed in JP-A-2005-238631, the heat exchange with the mold in the high quality required surface is made to be uniform. As a result, as described above, in regard to manufacturing of the injection-molded product in which surface accuracy higher than that of other portions is required only in a part of the high quality required surface, in the high quality required surface, it is more difficult to suppress sinking which occurs at a portion in which surface accuracy higher than that of other portions is required, compared to sinking that occurs at other portions.

### SUMMARY

An advantage of some aspects of the invention is to suppress sinking, which occurs at a portion in which surface accuracy higher than that of other portions is required, more when compared to sinking that occurs at other portions in which the required surface accuracy is low, in regard to an injection-molded product in which surface accuracy higher than that of other portions is required only in a part of the high quality required surface in which high surface accuracy is required.

According to a first aspect of the invention, there is provided an injection mold (for example, an injection mold 1 in FIG. 1). The injection mold includes: a high quality required surface forming insert (for example, a high quality required surface forming insert 6 in FIG. 1) that is mounted on at least one of a pair of molds (for example, a fixed side mold 2 and a movable side mold 4 in FIG. 1) in which mold opening and mold closing are possible; and a molding space forming section (for example, an inner wall surface of a fixed side opening portion 8, a surface, which is opposite to the fixed side opening portion 8, of the movable side mold 4, and a surface, which is opposite to the fixed side opening portion 8, of the high quality required surface forming insert 6 of FIG. 1) that forms a molding space, which is formed between the pair of molds including the high quality required surface forming insert in the mold closed state, and into which a molten resin (for example, a molten resin R in FIG. 3) is injected. The high quality required surface forming insert includes a first insert member (for example, a first insert member 12 in FIGS. 2A and 2B) that is opposite to the molding space, and a second insert member (for example, a second insert member 14 in FIGS. 2A and 2B) that has thermal conductivity lower than that of the first insert member, is connected to the first insert member, and is opposite to the molding space.

According to this configuration, the progress of solidification of the molten resin, which is injected to the molding space and a surface thereof is solidified, at the inside thereof, becomes slow in a portion that comes into contact with the second insert member compared to a portion that comes into contact with the first insert member.

Therefore, in shrinkage that occurs in the molten resin when internal solidification is in progress, shrinkage, which occurs at a surface that comes into contact with the high quality required surface forming insert, may be concentrated on a portion that comes into contact with the second insert member.

As a result, in the molten resin in which the internal solidification is in progress, in regard to the surface that comes into contact with the high quality required surface forming insert, the sinking that occurs at the portion that comes into contact with the first insert member may be suppressed, and therefore quality of the injection-molded product may be improved.

In the injection mold, the high quality required surface forming insert may include an insert surface layer portion (for example, an insert surface layer portion 16 in FIGS. 2A and 2B) that is a layer that covers surfaces, which are opposite to the molding space, of the first insert member and the second insert member.

According to this configuration, even when step difference is formed between the first insert member and the second insert member, in the surface, which comes into contact with the high quality required surface forming insert of the molten resin in which the internal solidification is in progress, the formation of step difference at a position that corresponds to a connecting portion between the first insert member and the second insert member may be suppressed.

Therefore, even when the step difference is formed at the connecting portion between the first insert member and the second insert member, the surface, which comes into contact with the high quality required surface forming insert, of the molten resin in which the internal solidification is in progress may be formed as a surface that has high surface accuracy that is required.

In the injection mold, thermal conductivity of the insert surface layer portion may be higher than that of the first insert member.

According to this configuration, when being compared to a case in which a material having thermal conductivity lower than that of a material to form the first insert member is used as a material to form the insert surface layer portion, cooling by heat exchange with the first insert member in the surface, which comes into contact with the high quality required surface forming insert, of the molten resin in which the internal solidification is in progress may be permitted to progress quickly compared to cooling by heat exchange with the second insert member.

Therefore, even when the step difference occurs at the connecting portion between the first insert member and the second insert member, the step difference may be suppressed by the insert surface layer portion, and in the shrinkage that occurs in the molten resin when the internal solidification is in progress, the shrinkage, which occurs at the surface that comes into contact with the high quality required surface forming insert, may be concentrated on the portion that comes into contact with the second insert member.

In the injection mold, the thermal conductivity of the insert surface layer portion may be equal to or lower than that of the first insert member and may be equal to or higher than that of the second insert member.

According to this configuration, choices for a material to form the insert surface layer portion may be increased compared to a case in which the thermal conductivity of the insert surface layer portion is set to be higher than that of the first insert member.

Therefore, the freedom of design of the injection mold may be improved.

In addition, according to a second aspect of the invention, there is provided an injection-molded product (for example, an injection-molded product P in FIGS. 5A and 5B). The injection-molded product is formed of a solidified molten resin and includes a high quality required surface (for example, a high quality required surface P1 in FIGS. 5A and 5B) and a high quality not-required surface (for example, a high quality not-required surface P2 in FIGS. 5A and 5B) that has surface accuracy lower than that of the high quality required surface. The high quality required surface includes a high surface accuracy required portion (for example, a high surface accuracy required portion A1 in FIGS. 5A and 5B) and a high surface accuracy not-required portion (for example, a high surface accuracy not-required portion A2 in FIGS. 5A and 5B) in which the surface accuracy is lower than that of the high surface accuracy required portion.

According to this configuration, the shrinkage, which occurs at the high quality required surface when the internal solidification of the molten resin is in progress, may be concentrated to the high surface accuracy not-required portion of the high quality required surface, such that the surface accuracy of the high surface accuracy required portion may be preferentially improved.

Therefore, since in the high quality required surface, the sinking, which occurs at the high surface accuracy required portion in which surface accuracy higher than that of the high surface accuracy not-required portion is required, may be suppressed more compared to the high surface accuracy not-required portion, the quality of the injection-molded product may be improved.

In the injection-molded product, the high surface accuracy required portion may make up the center of the high quality required surface and the periphery of the center, the high surface accuracy not-required portion may make up a portion that becomes more distant from the center of the high quality required surface than the high surface accuracy required portion in the high quality required surface, and as it becomes distant from the boundary between the high surface accuracy required portion and the high surface accuracy not-required portion, the surface accuracy of the high surface accuracy not-required portion may decrease.

According to this configuration, as it becomes distant from the boundary between the high surface accuracy required portion and the high surface accuracy not-required portion, the surface accuracy of the high surface accuracy not-required portion decreases.

Therefore, since an injection-molded product in which sinking, which occurs at a portion distant from the center, that is, at a portion in which high surface accuracy is not required is large in the high quality required surface, may be manufactured, a decrease in quality that is required in the injection-molded product may be suppressed.

The injection-molded product may be an optical element including an optical prism. According to this configuration, a control of light in the optical element may be reliably performed.

In addition, according to a third aspect of the invention, there is provided an ink tank including the optical prism. According to this configuration, accuracy of detecting whether or not ink in the ink tank is present may be increased.

In addition, according to a fourth aspect of the invention, there is provided a recording device including the ink tank according to the third aspect of the invention. According to this configuration, accuracy of detecting whether or not ink is present in the ink tank may be increased.

In addition, according to a fifth aspect of the invention, there is provided an injection molding method. The method includes: injecting a molten resin into a molding space, which is formed in a mold closed state, between a pair of molds including a high quality required surface forming insert that is mounted in at least one of the pair of molds in which mold opening and mold closing are possible; and cooling the molten resin, which is injected into the molding space in the injecting of the molten resin, in a state in which the molten resin comes into contact with the high quality required surface forming insert to solidify the molten resin. In the cooling of the molten resin, the molten resin, which is in a state of being brought into contact with a first insert member and a second insert member having thermal conductivity lower than that of the first insert member, is cooled and solidified by heat exchange with the first insert member and the second insert member. The first insert member and the second insert member are provided in the high quality required surface forming insert.

According to this configuration, in the cooling of the molten resin, the progress of the solidification of the molten resin, which is injected into the molding space and a surface thereof is solidified, at the inside of the molten resin becomes slow in a portion that comes into contact with the second insert member compared to a portion that comes into contact with the first insert member.

Therefore, in the cooling of the molten resin, in shrinkage that occurs in the molten resin when internal solidification is in progress, shrinkage, which occurs at a surface that comes into contact with the high quality required surface forming insert, may be concentrated to a portion that comes into contact with the second insert member.

As a result, in the molten resin in which the internal solidification is in progress, in regard to the surface that comes into contact with the high quality required surface forming insert, the sinking that occurs at the portion that comes into contact with the first insert member may be suppressed, and therefore quality of the injection-molded product may be improved.

In the injection molding method, in the cooling of the molten resin, the molten resin, which is in a state of being brought into contact with an insert surface layer portion, may be cooled and solidified by the heat exchange with the first insert member and the second insert member through the surface layer portion. The insert surface layer portion is a layer that covers surfaces, which are opposite to the molding space, of the first insert member and the second insert member.

According to this configuration, even when step difference is formed between the first insert member and the second insert member, in the surface, which comes into contact with the high quality required surface forming insert, of the molten resin in which the internal solidification is in progress, in the cooling of the internal resin, the formation of step difference at a position that corresponds to a connecting portion between the first insert member and the second insert member may be suppressed.

Therefore, even when the step difference is formed at the connecting portion between the first insert member and the second insert member, in the cooling of the molten resin, the surface, which comes into contact with the high quality required surface forming insert, of the molten resin in which the internal solidification is in progress may be formed as a surface that has high surface accuracy that is required.

In addition, according to a sixth aspect of the invention, there is provided an injection-molded product that is formed in accordance with the injection molding method according to the fifth aspect of the invention.

The injection-molded product may be an optical element.

In the injection-molded product, the optical element may be an optical prism.

### BRIEF DESCRIPTION OF THE DRAWINGS

The invention will be described with reference to the accompanying drawings, wherein like numbers reference like elements.

FIG. 1 is a view illustrating a schematic configuration of an injection mold.

FIGS. 2A and 2B are views illustrating a configuration of a high quality required surface forming insert.

FIG. 3 is a view illustrating a schematic configuration of the injection mold in a state in which a molten resin is injected into a molding space in an injection process.

FIG. 4 is a view illustrating a schematic configuration of the injection mold in a state in which a fixed side mold and a moving side mold are opened in a discharge process.

FIGS. 5A and 5B are views illustrating a configuration of an injection-molded product.

FIGS. 6A and 6B are views illustrating an ink tank that is provided with an optical prism, and FIG. 6C is an external perspective view of an ink jet printer.

### DESCRIPTION OF EXEMPLARY EMBODIMENTS

Hereinafter, embodiments of an injection-molded product, an injection mold, and an injection molding method according to the invention will be described with reference to the attached drawings.

### First Embodiment

Configuration

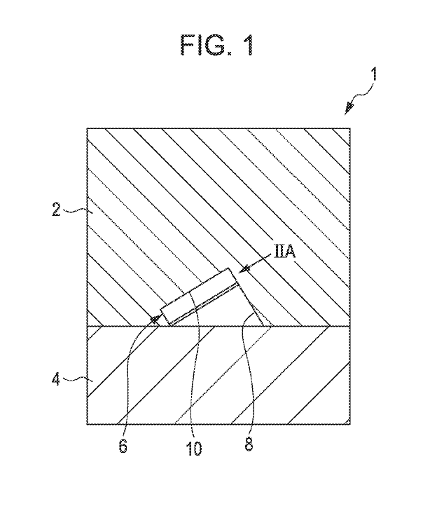

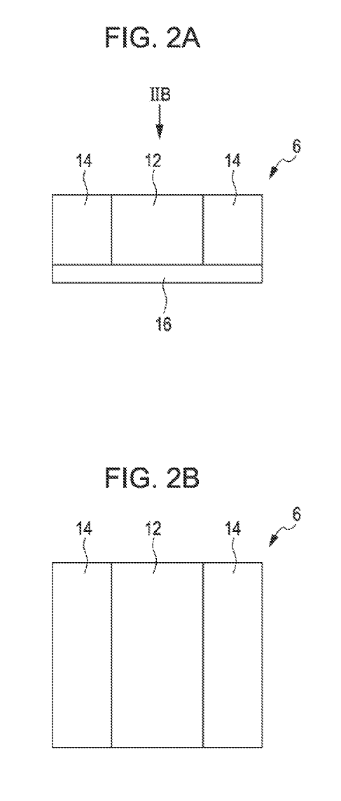

First, a configuration of the injection mold according to a first embodiment will be described with reference to FIG. 1 to FIG. 2B.

FIG. 1 shows a view illustrating a schematic configuration of an injection mold 1 and is a cross-sectional view of the injection mold 1.

The injection mold 1 shown in FIG. 1 is a device that injects a molten resin into a molding space (cavity), which is formed between a pair of molds in a case where the pair of molds in which mold opening and mold closing are possible is in a mold closed state, and solidifies the injected molten resin to manufacture an injection-molded product. In addition, a description with respect to the molding space will be made later.

Here, in the first embodiment, a description will be made with respect to a case in which the injection-molded product has light transmission properties and a cross-sectional shape thereof is a prism shape of a right-angled triangle or substantially right-angled triangle, as an example. In this case, the injection-molded product is, for example, a part, which is provided in an ink cartridge provided in a printing machine (printer), and through which light is transmitted to detect an ink residual quantity.

Therefore, in the first embodiment, a description will be made with respect to a case in which a transparent resin is used as the molten resin. In addition, the configurations of the injection-molded product and the molten resin material are not limited to the above-described configuration.

Here, as the molten resin material, for example, resins such as ABS (Acrylonitrile Butadiene Styrene copolymer synthetic resin), PS (polystyrene), AS (Acrylonitrile Styrene copolymer compound), PMMA (Poly Methyl Methacrylate), PC (Polycarbonate), and a cyclic olefin-based resin may be used.

As described above, in a case where the injection-molded product is a light transmissive part, it is required that in the injection-molded product, a surface (a functional surface), which makes up a light incident surface or a light emitting surface, or both of them, is a surface in which a degree of variation from a desired shape is small. In addition, this is true of a reflective surface in a case where the reflective surface is present. This represents that a surface in which a degree of variation in unevenness, surface roughness, or the like is small is required for a surface (a functional surface), in a case where for example, a flat surface with a desired shape is set in the surface (the functional surface) of the injection-molded product.

Therefore, in the first embodiment, a description will be made with respect to a case in which as an example, the injection-molded product is set as an optical prism that is formed of a solidified molten resin and that has a high quality required surface that is a functional surface in which high surface accuracy is required, and a high quality not-required surface in which surface accuracy is lower than that of the high quality required surface.

Furthermore, in the first embodiment, a description will be made with respect to a case where the injection-molded product has a configuration in which only a part of the high quality required surface, specifically, only the center of the high quality required surface and the periphery of the center make up a high surface accuracy required portion in which high flatness is required as surface accuracy higher than that of other portions of the high quality required surface. Along with this, in the first embodiment, portions (other portions) other than the high surface accuracy required portion in the high quality required surface are described as a high surface accuracy not-required portion.

For example, in a case where the functional surface, which functions as a prism, has three surfaces of an incident surface, a reflective surface, and an emitting surface, a configuration in which light is incident to any one surface, is reflected on the remaining two surfaces, and is emitted from the same surface as the incident surface may be considered. In this case, it is preferable that in each surface of these three surfaces, a portion from which main light beams are transmitted or on which the main light beams are reflected be set as the high surface accuracy required portion, and portions other than this portion be set as the high surface accuracy not-required portion.

In addition, in a case where the functional surface that functions as the prism includes two surfaces of the incident surface and the emitting surface, it is preferable that in each surface of these two surfaces, a portion from which the main light beams are transmitted or on which the main light beams are reflected be set as the high surface accuracy required portion, and portions other than this portion be set as the high surface accuracy not-required portion. According to this configuration, the path of the light may be reliably controlled.

As shown in FIG. 1, the injection mold 1 includes a fixed side mold 2 and a movable side mold 4 as the above-described pair of molds. In addition to this, the injection mold 1 includes a high quality required surface forming insert 6. In addition, in FIG. 1, the injection mold 1 in a mold closed state is shown.

The fixed side mold 2 is attached to a fixed plate (not shown), which maintains the injection mold 1, using a bolt or the like, and a fixed side opening portion 8, an insert accommodating cavity portion 10, and a resin passage (not shown) are formed inside the fixed side mold 2.

The fixed side opening portion 8 is a space into which a molten resin is filled, and is opened in a surface (in FIG. 1, a lower side surface), which is opposite to the movable side mold 4, of the fixed side mold 2.

The insert accommodating cavity portion 10 is a space in which the high quality required surface forming insert 6 may be accommodated, and is formed to be continuous to the fixed side opening portion 8.

The resin passage is formed so that the molten resin may flow therethrough. In addition, one end side of the resin passage is opened toward the fixed side opening portion 8, and the other end side of the resin passage communicates with a resin injecting device (not shown).

The resin injecting device is a device that weights and plasticizes the molten resin material (solid resin material or the like) in response to the volume and shape of the injection-molded product, and injects the weighted and plasticized molten resin to the resin passage.

In addition, the fixed side mold 2 includes an ejector pin (not shown) that may protrude into the fixed side opening portion 8. In a normal state, this ejector pin does not protrude into the fixed side opening portion 8.

In addition, as a specific configuration example of operating the ejector pin, for example, a configuration in which an upper side plate in which the ejector pin and a return pin in the related art are provided, and a lower side plate that presses and fixes the ejector pin and the return pin are provided. In this case, the ejector pin is made to protrude into the fixed side opening portion 8 by the ejector device in the related art, which is provided in the injection mold 1, and thereby the injection-molded product that is solidified in the fixed side opening portion 8 is ejected therefrom.

The movable side mold 4 is connected to a driving mechanism (not shown), and is formed to move in a vertical direction (a vertical direction in FIG. 1) using a driving force that is generated by the driving mechanism. In addition, the driving mechanism includes, for example, a mechanical type using a rotational movement of a motor, or a hydraulic type in which pressure is applied to a liquid such as oil.

The high quality required surface forming insert 6 is formed in a flat plate shape and is accommodated inside the insert accommodating cavity portion 10. In addition, in the first embodiment, as an example, the configuration of the injection mold 1 is set to a configuration in which only one high quality required surface forming insert 6 is provided.

Here, in the first embodiment, as described above, the injection-molded product has a configuration in which the high quality required surface and the high quality not-required surface are provided and a cross-sectional shape is a prism shape of a right-angled triangle or a substantially right-angled triangle.

Therefore, in the first embodiment, the fixed side mold 2, the movable side mold 4, and the high quality required surface forming insert 6 are provided in such a manner that the cross-sectional shape of the molding space corresponds to a prism shape of a right-angled triangle or a substantially right-angled triangle. Wherein the molding space is formed between an inner wall surface of the fixed side opening portion 8, a surface which is opposite to the fixed side opening portion 8 of the movable side mold 4, and a surface which is opposite to the fixed side opening portion 8 of the high quality required surface forming insert 6 in a case where the pair of molds in which the mold closing and the mold opening are possible, that is, the fixed side mold 2 and the movable side mold 4 are in a mold closed state.

That is, in the first embodiment, the inner wall surface of the fixed side opening portion 8, the surface, which is opposite to the fixed side opening portion 8, of the movable side mold 4, and the surface, which is opposite to the fixed side opening portion 8, of the high quality required surface forming insert 6 make up the molding space forming section that forms the molding space. Therefore, the injection mold 1 according to the first embodiment is provided with the molding space forming section that is formed between the fixed side mold 2 including the high quality required surface forming insert 6 and the movable side mold 4 in the mold closed state, and that forms the molding space into which the molten resin is injected.

Here, in the first embodiment, among surfaces of the injection-molded product, a surface that is opposite to the high quality required surface forming insert 6 in the molding space is set as the high quality required surface that is a functional surface in which a flat surface with a desired shape is set, a degree of variation in unevenness, surface roughness, or the like is small, and high surface accuracy is required. Along with this, in the first embodiment, among surfaces of the injection-molded product, surfaces that are not opposite to the high quality required surface forming insert 6 in the molding space are set as the high quality not-required surface in which surface accuracy is lower than that of the high quality required surface.

In addition, as shown in FIGS. 2A and 2B, the high quality required surface forming insert 6 includes a first insert member 12, two second insert members 14, and an insert surface layer portion 16. In addition, FIGS. 2A and 2B show views illustrating a configuration of the high quality required surface forming insert 6, in which FIG. 2A is a view taken along an arrow IIA in FIG. 1, and FIG. 2B is a view taken along an arrow IIB in FIG. 2A. In addition, in FIGS. 2A and 2B, for explanation, portions other than the high quality required surface forming insert 6 are not shown.

The first insert member 12 is formed of a hexahedron, and a surface that is opposite to the fixed side opening portion 8 is formed as a flat surface. As described above, this is because in the first embodiment, the high surface accuracy required portion of the injection-molded product is required to have high flatness as surface accuracy higher than that of other portions of the high quality required surface. In addition, in this first embodiment, a description will be made with respect to a case in which the first insert member 12 is formed in a rectangular parallepiped.

In addition, in the first embodiment, a description will be made with respect to a case in which a copper alloy is used as a material to form the first insert member 12.

Both of the two second insert members 14 are formed in hexahedrons, and a surface that is opposite to the fixed side opening portion 8 is formed as a flat surface. That is, a surface, which is opposite to the fixed side opening portion 8, of the first insert member 12 and surfaces, which are opposite to the fixed side opening portion 8, of the second insert members 14 are flush with each other. In addition, in the first embodiment, a description will be made with respect to a case in which the two second insert members 14 are formed in a rectangular parallepiped.

In addition, the two second insert members 14 are connected to the first insert member 12 using a method such as metal junction in a state where they are opposite to each other with the first insert member 12 interposed therebetween. Furthermore, surfaces, which are opposite to the fixed side opening portion 8, of the second insert members 14 are continuous to the surface, which is opposite to the fixed side opening portion 8, of the first insert member 12. In addition, as a method of connecting the first insert member 12 and the second insert members 14, in addition to the metal junction, a method of inserting a bolt through the inside of the first insert member 12 and the second insert members 14 may be exemplified.

In this manner, the first insert member 12 makes up a portion, which corresponds to the high surface accuracy required portion of the injection-molded product, of the high quality required surface forming insert 6. In addition to this, the second insert members 14 make up a portion, which correspond to the high surface accuracy not-required portion of the injection-molded product, of the high quality required surface forming insert 6.

In addition, the second insert members 14 are formed of a material in which thermal conductivity is lower than that of a material to form the first insert member 12. That is, the thermal conductivity of the second insert members 14 is lower than that of the first insert member 12.

Here, in this first embodiment, as described above, since the copper alloy is used as the material to form the first insert member 12, a description will be made with respect to a case in which iron that is a material having thermal conductivity lower than that of the copper alloy to form the first insert member 12 is used as a material to form the second insert members 14.

In addition, the material to form the second insert members 14 is not limited to the iron, and for example, any material such as ceramic and tungsten as long as this material has thermal conductivity lower than that of the material to form the first insert member 12.

The insert surface layer portion 16 is a layer that is formed on surfaces, which are opposite to the fixed side opening portion 8, of the first insert member 12 and the second insert members 14 that are connected to each other, and covers surfaces, which are opposite to the molding space, of the first insert member 12 and the second insert members 14 that are connected to each other. That is, the first insert member 12 and the respective second insert members 14 are opposite to the molding space with the insert surface layer portion 16 interposed therebetween.

As a method of forming the insert surface layer portion 16, for example, a method, which is general as a method of generating a surface film, such as plating, sputtering, and thermal spraying may be used. In addition, in addition to the method of generating the surface film, as the method of forming the insert surface layer portion 16, for example, a method of adhering metal having an average value of thickness of 1 mm or less (preferably, within a range of several μm to several tens μm) by diffused junction or adhesion may be used.

The thickness (film thickness) of the insert surface layer portion 16 is a thickness in a case where the surface, which is opposite to the fixed side opening portion 8, of the insert surface layer portion 16 becomes a surface corresponding to the high surface accuracy that is required for the high quality required surface. The insert surface layer portion 16 having this thickness is formed, for example, by forming the insert surface layer portion 16 on the first insert member 12 and the respective second insert members 14 and by performing processes such as polishing and cutting with respect to the surface, which is opposite to the fixed side opening portion 8, of the insert surface layer portion 16.

In addition, in this first embodiment, a description will be made with respect to a case in which as an example, an average value of the thickness of the insert surface layer portion 16 is set to a range of several μm to several tens μm.

In addition, in this first embodiment, a description will be made with respect to a case in which as an example, silver (Ag) that is a material having thermal conductivity higher than that of the copper (Cu) alloy to form the first insert member 12 is used as a material to form the insert surface layer portion 16. That is, the thermal conductivity of the insert surface layer portion 16 is set to be higher than that of the first insert member 12 and the second insert members 14.

Injection Molding Method

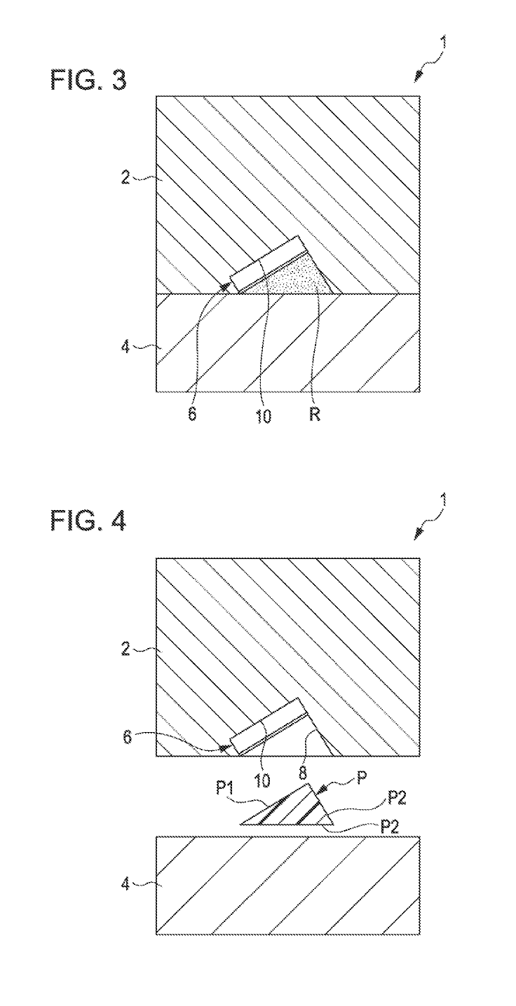

Next, a description will be made with respect to a process of manufacturing the injection-molded product by using the injection mold 1 having the above-described configuration with reference to FIGS. 3 and 4 while referring to FIGS. 1 to 2B.

In the first embodiment, when manufacturing the injection-molded product, an injection molding method including an injection process, a pressure maintaining process, a cooling process, and an ejection process is used.

Injection Process, Pressure Maintaining Process, and Cooling Process

Hereinafter, an operation of the injection mold 1 in the injection process, the pressure maintaining process, and the cooling process will be described. In addition, in the following description, it is assumed that the pair of molds in which the mold opening and the mold closing are possible, that is, the fixed side mold 2 and the movable side mold 4 are in a mold opened state.

The injection process is a process of injecting the molten resin into the above-described injection space. In this process, first, the movable side mold 4 is made to move to the fixed side mold 2 side, and then the movable side mold 4 and the fixed side mold 2 are brought into contact with each other, and thereby as shown in FIG. 1, the fixed side mold 2 and the movable side mold 4 enter the mold closed state.

The movable side mold 4 is made to move and thereby the molding space is made to have a shape corresponding to the injection-molded product. Then, as shown in FIG. 3, a molten resin R that is weighted and plasticized is injected into the injection space. Then, the injection process is terminated, and the process transitions to the pressure maintaining process. In addition, FIG. 3 shows a view illustrating a schematic configuration of the injection mold 1 in a state in which the molten resin is injected into the molding space in the injection process, and shows a cross-sectional view of the injection mold 1.

In the pressure maintaining process, the position of the movable side mold 4 is maintained, and in the molding space, the pressure of the molten resin R that is injected in the injection process is maintained. Then, the pressure maintaining process is terminated, and the process transitions to the cooling process.

In the cooling process, the molten resin R, which is injected to the molding space in the above-described injection and pressure maintaining processes, is cooled and solidified by a heat exchange operation between the fixed side mold 2 including the high quality required surface forming insert 6 and the movable side mold 4 in a state in which the molten resin R is brought into contact with the high quality required surface forming insert 6.

Specifically, the molten resin R, which is in a state of being brought into contact with the first insert member 12 and the second insert members 14, is cooled and solidified by the heat exchange between the first insert member 12 and the second insert members 14.

At this time, in the molten resin R, sinking occurs due to shrinkage that occurs when internal solidification is in progress.

Here, the high quality required surface forming insert 6 of the first embodiment includes the first insert member 12 that makes up a portion corresponding to the high surface accuracy required portion of the injection-molded product, and the second insert members 14 that make up a portion corresponding to the high surface accuracy not-required portion of the injection-molded product and are formed of a material having thermal conductivity lower than that of a material to form the first insert member 12.

Therefore, in the cooling process, in the high quality required surface of the injection-molded product, the cooling by the heat exchange between the portion, which becomes the high surface accuracy required portion of the injection-molded product, and the first insert member 12 is promoted more than the cooling by the heat exchange between the portion, which becomes the high surface accuracy not-required portion of the injection-molded product, and the second insert members 14.

Therefore, the progress of the solidification inside the molten resin R whose surface is solidified becomes slower in the portion that comes into contact with the second insert members 14, that is, in the portion, which becomes the high surface accuracy not-required portion, of the injection-molded product than the progress of the solidification in the portion that comes into contact with the first insert member 12, that is, in the portion, which becomes the high surface accuracy required portion, of the injection-molded product.

Therefore, according to the injection mold 1 and the injection molding method of the first embodiment, in the shrinkage that occurs in the molten resin R when the internal solidification is in progress, the shrinkage, which occurs at the high quality required surface of the injection-molded product, may be concentrated to the portion that comes into contact with the second insert members 14, that is, the portion, which becomes the high surface accuracy not-required portion, of the injection-molded product.

Therefore, according to the injection mold 1 and the injection molding method of the first embodiment, in the molten resin R in which the internal solidification is in progress, the sinking, which occurs in the high surface accuracy required portion of the high quality required surface of the injection-molded product, may be suppressed.

In this manner, when the solidification of the molten resin R is completed and thereby an injection-molded product is formed, the injection-molded product in which an amount of depression of a sink mark formed in the high surface accuracy required portion of the high quality required surface is smaller than an amount of depression of a sink mark formed in the high surface accuracy not-required portion is formed. When the injection-molded product is formed, the cooling process is terminated and the process transitions to the ejection process.

That is, since in the high quality not-required surface of the injection-molded product formed by the solidified molten resin R, the amount of depression of the sink mark formed in the high surface accuracy required portion is larger than the amount of depression of the sink mark formed in the high surface accuracy not-required portion, the surface accuracy of the high surface accuracy not-required portion becomes lower than that of the high surface accuracy required portion.

Here, the “sink mark” is a shallow depression formed in the surface of the injection-molded product, and is a portion that is formed when the surface of the injection-molded product is depressed due to local internal shrinkage that occurs as the molten resin injected into the molding space is cooled.

In addition, the high quality required surface forming insert 6 of the first embodiment has a configuration in which the insert surface layer portion 16 is formed on surfaces, which are opposite to the fixed side opening portion 8, of the first insert member 12 and the second insert members 14 that are connected to each other.

That is, in the injection molding method of the first embodiment, in the cooling process, the molten resin R, which is in a state of being brought into contact with the insert surface layer portion 16, is cooled and solidified by heat exchange with the first insert member 12 and the second insert members 14 through the insert surface layer portion 16.

Therefore, in the cooling process, the molten resin R is solidified in a state in which the high quality required surface of the injection-molded product comes into contact with a surface, which is opposite to the fixed side opening portion 8, of the insert surface layer portion 16, that is, a surface corresponding to the high surface accuracy that is required for the high quality required surface.

Therefore, according to the injection mold 1 and the injection molding method of the first embodiment, even when step difference is formed at a connecting portion between the first insert member 12 and the second insert members 14, the high quality required surface of the injection-molded product may be formed as a surface that has high surface accuracy that is required.

In addition, in the high quality required surface forming insert 6 of the first embodiment, as a material to form the insert surface layer portion 16, a material, which has thermal conductivity higher than that of a material to form the first insert member 12 and the second insert members 14, is used.

Therefore, when being compared to a case in which a material having thermal conductivity lower than that of a material to form the first insert member 12 and the second insert members 14 is used as a material to form the insert surface layer portion 16, in the high quality required surface of the injection-molded product, the cooling by the heat exchange with the first insert member 12 may be made to rapidly progress compared to the cooling by the heat exchange with the second insert members 14.

In addition, since in the high quality required surface forming insert 6 of the first embodiment, the insert surface layer portion 16 is formed on a surface, which is opposite to the fixed side opening portion 8, of the first insert member 12, it is possible to suppress that the first insert member 12, which is formed of copper having heat resistance lower than that of iron, comes into contact with the molten resin R and is deteriorated (damaged, modified, or the like).

Ejection Process

Hereinafter, an operation of the injection mold 1 in the ejection process will be described.

In the ejection process, first, with respect to the fixed side mold 2 and the movable side mold 4 that are in a mold closed state, the movable side mold 4 is made to move in a direction to be distant from the fixed side mold 2, and thereby as shown in FIG. 4, the movable side mold 4 and the fixed side mold 2 are separated, and fixed side mold 2 and the movable side mold 4 enter the mold opened state. In addition, FIG. 4 shows a schematic configuration of the injection mold 1 in a state in which the fixed side mold 2 and the movable side mold 4 are made to enter the mold opened state in the ejection process, and shows a cross-sectional view of the injection mold 1.

In addition, after the fixed side mold 2 and the movable side mold 4 are made to enter the mold open state, an ejector pin is made to protrude into the inside of the fixed side opening portion 8, an injection-molded product P that is solidified in the fixed side opening portion 8 (molding space) is ejected, and then the manufacturing of the injection-molded product P is terminated. In addition, in FIG. 4, a symbol “P1” is given to represent the high quality required surface of the injection-molded product P, and a symbol “P2” is given to represent the high quality not-required surface of the injection-molded product P.

As described above, according to the injection molding method of the first embodiment, in the molten resin R in which the internal solidification is in process in the cooling process, the sinking that occurs in the high surface accuracy required portion of the high quality required surface P1 of the injection-molded product P may be suppressed.

Therefore, the quality of the injection-molded product P may be improved.

Configuration of Injection-Molded Product P

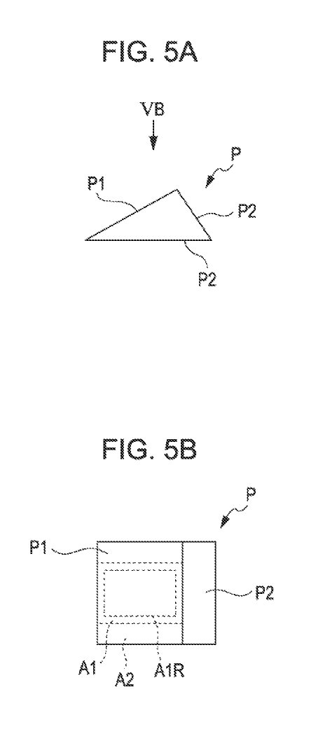

Next, a description will be made with respect to a configuration of the injection-molded product P that is manufactured by using the above-described injection mold 1 and injection molding method with reference to FIGS. 5A and 5B while referring to FIGS. 1 to 4.

FIGS. 5A and 5B show views illustrating a configuration of the injection-molded product P, in which FIG. 5A shows a side view of the injection-molded product P, and FIG. 5B shows a view taken along an arrow VB in FIG. 5A.

As described above, the injection-molded product P is formed of the molten resin R that is solidified, and as shown in FIGS. 5A and 5B, has a high quality required surface P1 and a high quality not-required surface P2 in which surface accuracy is lower than that of the high quality required surface P1.

In addition, as shown in FIGS. 5A and 5B, the high quality required surface P1 has a high surface accuracy required portion A1 and a high surface accuracy not-required portion A2 in which the surface accuracy is lower than that of the high surface accuracy required portion A1.

The high surface accuracy required portion A1 is a portion that is opposite to the first insert member 12 of the high quality required surface forming insert 6 with the insert surface layer portion 16 interposed therebetween in the above-described injection mold 1, and makes up the center of the high quality required surface P1 and the periphery of the center. In addition, in FIG. 5B, in the high surface accuracy required portion A1, an actual use range A1R that is a range in which a function required for the injection-molded product P is actually used is indicated by a region surrounded by a dotted line. In addition, in FIG. 5B, a boundary between the high surface accuracy required portion A1 and the high surface accuracy not-required portion A2 is represented by two broken lines.

The high surface accuracy not-required portion A2 is a portion that is opposite to the second insert members 14 of the high quality required surface forming insert 6 with the insert surface layer portion 16 interposed therebetween in the above-described injection mold 1, and makes up portions other than the high surface accuracy required portion A1 in the high quality required surface P1.

In the first embodiment, as described above, in the cooling process at the time of manufacturing the injection-molded product P, the internal solidification of the molten resin R progresses in a state in which the cooling by the heat exchange, between the portion that becomes the high surface accuracy required portion A1 and the first insert member 12, is promoted more than the cooling by the heat exchange between the portion that becomes the high surface accuracy not-required portion A2 and the second insert members 14.

Therefore, in shrinkage that occurs in the molten resin R when the internal solidification is in progress in the cooling process, shrinkage that occurs at the high quality required surface P1 is concentrated to the portion that becomes the high surface accuracy not-required portion A2, and thereby sinking that occurs in the high surface accuracy required portion A1 may be suppressed more than sinking that occurs in the high surface accuracy not-required portion A2.

Therefore, since in the high quality required surface P1, the high surface accuracy required portion A1 has surface accuracy higher than that of the high surface accuracy not-required portion A2, a decrease in a quality that is required in the injection-molded product P may be suppressed.

In addition, in general, in the injection-molded product that is formed by the solidified molten resin, sinking that occurs at the center of a surface and the periphery of the center becomes larger than sinking that occurs in other portions.

However, according to the first embodiment, since the high quality required surface forming insert 6 is formed with the first insert member 12 interposed between the two second insert members 14, it is possible to manufacture the injection-molded product P in which the sinking that occurs at the center of the high quality required surface P1 and the periphery of the center is smaller than the sinking that occurs at other portions.

In addition, since the high quality required surface forming insert 6 is formed with the first insert member 12 interposed between the two second insert members 14, it is possible to manufacture the injection-molded product P in which as it becomes distant from the center of the high quality required surface P1 and the periphery of the center, the sinking which occurs is large.

Therefore, the high surface accuracy required portion A1 makes up the center of the high quality required surface P1 and the periphery of the center, and the high surface accuracy not-required portion A2 makes up a portion, which becomes more distant from the center of the high quality required surface P1 compared to the high surface accuracy required portion A1, in the high quality required surface P1.

In this manner, since the surface accuracy of the high surface accuracy not-required portion A2 decreases as it becomes distant from the boundary between the high surface accuracy required portion A1 and the high surface accuracy not-required portion A2, it is possible to manufacture the injection-molded product P in which the sinking, which occurs in a portion that becomes distant from the center of the high quality required surface P1, that is, a portion in which the high surface accuracy is not required, is large. Therefore, a decrease in the quality that is required for the injection-molded product P may be suppressed.

In addition, in the first embodiment, as described above, since the insert surface layer portion 16 is formed on surfaces which are opposite to the fixed side opening portion 8 of the first insert member 12 and the respective second insert members 14 that are connected to each other, even when step difference is formed between the first insert member 12 and the second insert members 14, the formation of the step difference at positions, which correspond to connecting portions between the first insert member 12 and the second insert members 14, in the high quality required surface P1 may be suppressed. Furthermore, even in a case in which the step difference is formed between the first insert member 12 and the second insert members 14, the surface accuracy of the high quality required surface P1 may be secured without necessitating secondary processing such as cutting and polishing with respect to the first insert member 12 and the second insert members 14 or the injection-molded product P.

Modification Example

Hereinafter, a modification example of the first embodiment will be described.

In the first embodiment, the high quality required surface forming insert 6 is described with a configuration in which the insert surface layer portion 16 is provided, but it is not limited thereto. The high quality required surface forming insert 6 may be configured not to include the insert surface layer portion 16. In this case, an effect due to the insert surface layer portion 16 may be prevented from being applied to the heat exchange between the first insert member 12 and the second insert members 14 and the molten resin R.

In addition, as described above, in a case where the high quality required surface forming insert 6 is configured not to include the insert surface layer portion 16, it is preferable that the step difference formed between the first insert member 12 and the second insert members 14 be reduced by processing such as cutting and polishing.

In addition, as described above, in a case where the high quality required surface forming insert 6 is configured not to include the insert surface layer portion 16, in the cooling process, the molten resin R that is in a state of being brought into contact with the first insert member 12 and the second insert members 14 is cooled and solidified by heat exchange with the first insert member 12 and the second insert members 14.

In addition, in the first embodiment, the thermal conductivity of the insert surface layer portion 16 is set to be higher than that of the first insert member 12 and the second insert members 14, but it is not limited thereto. The thermal conductivity of the insert surface layer portion 16 may be set to be equal to or lower than the thermal conductivity of the first insert member 12, and equal to or higher than the thermal conductivity of the second insert members 14.

In this case, since the choice of materials to form the insert surface layer portion 16 increases compared to a case in which the thermal conductivity of the insert surface layer portion 16 is set to be higher than that of the first insert member 12 and the second insert members 14, the freedom of design of the injection mold 1 may be improved.

In addition, in the first embodiment, since the high surface accuracy required portion A1 of the injection-molded product P is required to have high flatness as surface accuracy higher than that of the high surface accuracy not-required portion A2, the surface which is opposite to the fixed side opening portion 8 of the first insert member 12 is formed as a flat surface, but the configuration of the first insert member 12 is not limited thereto. That is, in a case where the high surface accuracy that is required for the high surface accuracy required portion A1 is, for example, surface accuracy in a curved surface in which high accuracy is required for a curvature, the surface, which is opposite to the fixed side opening portion 8, of the first insert member 12, may be formed in a shape such as a spherical surface that corresponds to the curved surface.

In addition, in the first embodiment, the high quality required surface forming insert 6 is formed with the first insert member 12 interposed between the two second insert members 14, but the configuration of the high quality required surface forming insert 6 is not limited thereto. That is, for example, in a case where the high surface accuracy required portion A1 is formed at a portion that becomes distant from the center of the high quality required surface P1, the high quality required surface forming insert 6 may be formed with a second insert member 14 interposed between two first insert members 12.

In addition, in the first embodiment, the injection mold 1 is configured to include only one high quality required surface forming insert 6, but it is not limited thereto. In a case where the injection-molded product P is configured to have a plurality of high quality required surfaces P1, the injection mold 1 may be configured to have a plurality of the high quality required surface forming inserts 6.

In addition, in the first embodiment, the high quality required surface forming insert 6 is configured to be mounted in the fixed side mold 2, but it is not limited thereto. The high quality required surface forming insert 6 may be configured to be mounted in the movable side mold 4. In addition, the high quality required surface forming insert 6 may be configured to be mounted in the fixed side mold 2 and the movable side mold 4, respectively.

In addition, in the first embodiment, the high quality required surface forming insert 6 is configured in such a manner that only one surface thereof is opposite to the fixed side opening portion 8, but it is not limited thereto. That is, for example, in a case where the injection-molded product P is configured to have two high quality required surfaces P1 that are adjacent to each other, two adjacent surfaces of the high quality required surface forming insert 6 may be opposite to the fixed side opening portion 8.

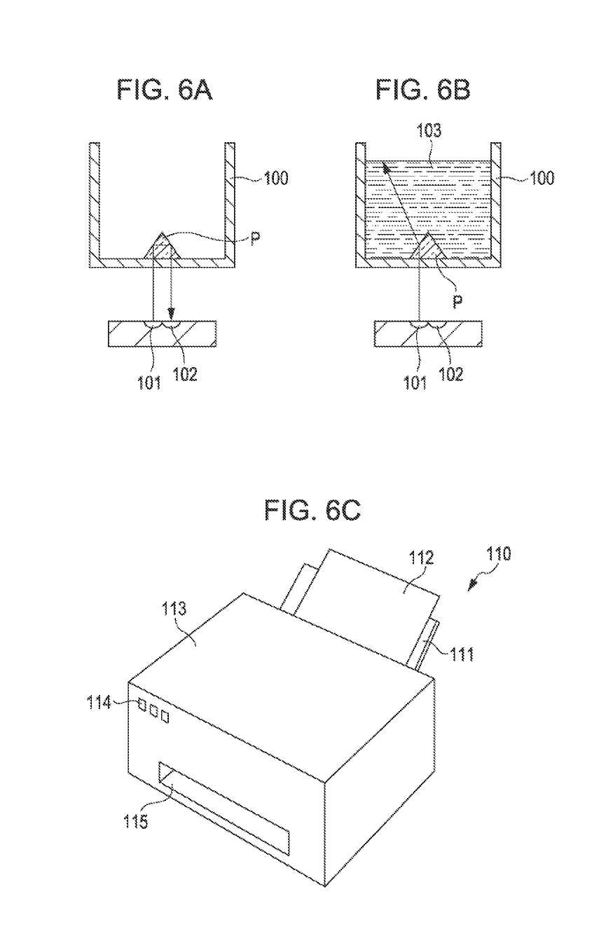

The injection-molded product P that is formed by the above-described injection molding method may be used as an optical prism P that is an optical element. FIGS. 6A and 6B show views illustrating an ink tank 100 including an optical prism P. The optical prism P may have a cross-sectional shape of a general equilateral triangle in which lengths of three sides are substantially equal to each other.

As shown in FIG. 6A, in a case where ink is not present in the ink tank 100, light emitted from the light emitting section 101 is refracted inside the optical prism P, and is returned to a light receiving section 102. As shown in FIG. 6B, in a case where the ink 103 is present in the ink tank 100, the light emitted from the light emitting section 101 is transmitted through the optical prism P and is not returned to the light receiving section 102.

FIG. 6C shows an external perspective view of an ink jet printer 110 as a recording device. The ink jet printer 110 is provided with a paper support 111 on which paper P is placed as a recording medium, and an operation button 114 that performs turning on and off of power or setting of printing conditions. The ink tank 100 shown in FIGS. 6A and 6B, and a liquid ejecting head (not shown) to which the ink is supplied from the ink tank 100 and which ejects the ink are provided inside a casing 113. The ink jet printer 110 feeds the paper P placed on the paper support 111 to the inside of the casing 113, forms characters or images on the paper P using the recording head (not shown), and discharges the paper P from a discharging port 115.

In addition, an equilateral triangle is exemplified as the optical prism, but it is needless to say that the invention is applicable to general triangles.

What is claimed is:

1. An injection molding method to make an optical element, comprising:
injecting a molten resin into a molding space, which is formed in a mold closed state, between a pair of molds including a high quality required surface forming insert that is mounted in at least one of the pair of molds in which mold opening and mold closing are possible; and
cooling the molten resin, which is injected into the molding space in the injecting of the molten resin, in a state in which the molten resin comes into contact with the high quality required surface forming insert to solidify the molten resin,
wherein in the cooling of the molten resin, the molten resin, which is in a state of being brought into contact with a first insert member and a second insert member having thermal conductivity lower than that of the first insert member, is cooled and solidified by heat exchange with the first insert member and the second insert member, the first insert member and the second insert member being provided in the high quality required surface forming insert,
wherein a location of the first insert member is corresponding to a portion from which main light beams are transmitted or on which the main light beams are reflected.

2. The injection molding method according to claim 1,
wherein two second insert members are opposite to each other with the first insert member.

3. The injection molding method according to claim 1,
wherein in the cooling of the molten resin, the molten resin, which is in a state of being brought into contact with an insert surface layer portion, is cooled and solidified by the heat exchange with the first insert member and the second insert member through the insert surface layer portion, the insert surface layer portion being a layer that covers surfaces, which are opposite to the molding space, of the first insert member and the second insert member.

4. The injection molding method according to claim 3,
wherein thermal conductivity of the insert surface layer portion may be set to be equal to or lower than the thermal conductivity of the first insert member and equal to or higher than the thermal conductivity of the second insert members 14.
